(19) United States
(12) Patent Application Publication
(10) Pub. No.: US 2020/0284506 A1
(43) Pub. Date: Sep. 10, 2020

(54) PROCESS FOR SEPARATION OF HYDROGEN AND OXYGEN

(71) Applicant: SABIC Global Technologies B.V., Bergen op Zoom (NL)

(72) Inventors: Nasser Ali Aldalaan, Riyadh (SA); Abdulaziz M. Al-Jodai, Riyadh (SA); Mubarik Ali Bashir, Riyadh (SA)

(21) Appl. No.: 16/082,109

(22) PCT Filed: May 5, 2017
(86) PCT No.: PCT/IB2017/052627

§ 371 Date: Sep. 4, 2018

Related U.S. Application Data
(60) Provisional application No. 62/335,428, filed on May 12, 2016.

(51) Int. Cl. F25J 3/02

(52) U.S. Cl. CPC F25J 3/0252; F25J 2210/50; F25J 3/0223

(57) ABSTRACT

Embodiments of the invention are directed to methods, processes, and systems for safely and reliably purifying hydrogen from a gas mixture containing hydrogen and oxygen using a cryogenic separation method.

### CROSS-REFERENCE TO RELATED APPLICATIONS

This application claims the benefit of priority of U.S. Provisional Patent Application No. 62/335,428 filed May 12, 2016, which is hereby incorporated by reference in its entirety.

### BACKGROUND

Hydrogen fuel production has gained increased attention as oil and other nonrenewable fuels become increasingly depleted and expensive. Methods such as photocatalytic water-splitting are being investigated to produce hydrogen fuel, which burns cleanly, and can also be used in a hydrogen fuel cell. Water-splitting holds particular interest since it utilizes water, an inexpensive renewable resource.

Technologies are currently under development for producing energy from renewable and sustainable resources such as water. Water can be used as a feedstock for photocatalytic splitting using sun light to split water molecules into hydrogen and oxygen. There is currently a lack of commercial methods or technologies for purifying hydrogen gas produced via this process. The process produces a highly explosive gas mixture, which requires using yet defined techniques and/or systems to separate and purify hydrogen from oxygen. Currently known methods for separating the gas mixture produced by water-splitting lack reliability, safety, and commercial scalability.

Thus, there remains a need for additional methods, processes, and systems for purifying hydrogen from a gas mixture containing hydrogen and oxygen.

### SUMMARY

Embodiments of the current disclosure relate to methods, processes, and systems that provide solutions to the problems associated with purifying a gaseous mixture of hydrogen and oxygen produced by a photocatalytic water-splitting process. The solution provides safe and reliable methods for purifying a highly flammable and explosive gas containing hydrogen and oxygen using cryogenic distillation processes.

Certain embodiments are directed to a process for separating hydrogen and oxygen from a gas mixture feed source, e.g., a feed source produced by photocatalytic splitting of water. The hydrogen and oxygen can be separated from a feed gas by compressing a feed source gas that includes H₂, O₂, and CO₂ to about 1.0, 2.0, 3.0, or 4.0 MPa forming a compressed feed source. The water and CO₂ can be filtered from the compressed feed source forming a filtered feed source, which then can be cooled to about −150, −160, −170, −180, or −190° C. forming a partially liquefied feed source. The partially liquefied feed source can be separated into an high pressure (HP) feed source and a low pressure (LP) feed source followed by compressing the HP feed source to a pressure of at least 0.8, 1.0, 2.0, 3.0, or 4.0 MPa, and then introducing the HP feed source into the bottom portion of a HP cryogenic separation column forming an oxygen enriched liquid at the bottom of the HP cryogenic separation column and a hydrogen enriched gas at the top of the HP cryogenic separation column. Expanding the LP feed source to a temperature of less than −130, −140, −150, or −160° C. and a pressure of at least 0.1, 0.2, 0.4, or 0.6 MPa can form a processed LP feed source. The processed LP feed source, oxygen enriched liquid from the HP column, and the hydrogen enriched gas from the HP column can be introduced to a LP cryogenic distillation/separation column to separate the oxygen from the hydrogen. The oxygen enriched product liquid can be collected from the bottom portion of the LP column and the hydrogen enriched product gas can be collected from the top of the LP column. The separated hydrogen product gas and an oxygen product liquid or gas stream can be stored and/or utilized. In certain aspects, the feed source can be compressed to at least 1.0 MPa (10 bar). In a further aspect, HP cryogenic distillation/separation process can be performed at about −120 to −150° C. and at a pressure of at least 0.8 to 2.0 MPa (8 to 20 bar). LP cryogenic distillation/separation process can be performed at about −180° C. and at a pressure of at least 0.2 MPa.

In certain aspects, the feed source can include about or at least 50, 60, 70, or 80 mol. % hydrogen. In a further aspect, the feed source can include about 70 mol. % hydrogen. The separated hydrogen stream or hydrogen product can include about or at least 90, 92, 94, 96, 98, or up to 99.5 mol. % hydrogen. In certain aspects, the hydrogen product can be about or at least 95 or 98 mol. % hydrogen. In certain aspects, the process or certain steps in the process can be performed under conditions and using equipment to minimize spark generation during compression and transfer of gas source or products.

Certain embodiments are directed to a hydrogen stream produced by the process described above and having at least 95, 98, 99, or up to 99.5 mol. % hydrogen.

Certain embodiments are directed to an oxygen off gas produced by the process described above and having at least 40, 50, 60, or up to 70 mol. % oxygen.

Other embodiments are directed to a gas separation system that includes one or more of: (a) a photocatalytic reactor configured to operate at approximately atmospheric pressure and to split water into hydrogen and oxygen forming a feed gas; (b) a high pressure (HP) cryogenic distillation column configured to receive a portion of a processed feed gas and separate the feed gas into an oxygen enriched liquid and a hydrogen enriched gas; (c) a low pressure (LP) cryogenic distillation column configured to receive an oxygen enriched liquid and a hydrogen enriched gas from the high pressure cryogenic distillation column and produce a hydrogen product gas and an oxygen product liquid. The system can further include a water and CO₂ removal unit(s), pre-processing unit (PPU), configured to receive the feed gas, dry the feed gas, and remove CO₂ and other impurities from the feed gas forming a processed feed gas, a portion of which is provided to a high pressure cryogenic distillation column and a portion of which is provided to a low pressure cryogenic distillation column. The system can further include an expander unit configured to receive at least a portion of the processed feed gas, expand the processed feed gas and provide the expanded gas/liquid to the low pressure cryogenic distillation column. The system can also further include one or more heat exchangers through which the feed gas, processed feed gas, hydrogen feed gas, or liquid oxygen passes during the process (depicted in FIG. 1 as rectangles). One or more coolers through which the feed gas, processed feed gas, hydrogen feed gas, or liquid oxygen passes can be included in the system. The system can further include one or more compressors through which the feed gas or processed feed gas passes. Hydrogen and/or oxygen storage device(s) to collect and store at least a portion of the enriched hydrogen product gas can be included. The system can further include one or more storage units for hydrogen product gas, oxygen product liquid, or oxygen product gas.

The following includes definitions of various terms and phrases used throughout this specification.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The use of the term “or” in the claims is used to mean “and/or” unless explicitly indicated to refer to alternatives only or the alternatives are mutually exclusive, although the disclosure supports a definition that refers to only alternatives and “and/or.”

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods and systems of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the methods and systems the present invention are their abilities to separate hydrogen from a highly flammable hydrogen/oxygen mixture.

Other objects, features and advantages of the present invention will become apparent from the following FIGURES, detailed description, and examples. It should be understood, however, that the FIGURES, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 is a block diagram of one embodiment of a cryogenic hydrogen purification system disclosed herein.

### DESCRIPTION

A discovery has been found that provides a solution to handling highly flammable mixtures produced from water-splitting processes. The solution is premised on using a cryogenic separation process or system to separate hydrogen from a highly flammable and explosive gaseous mixture containing hydrogen and oxygen. The solution can provide a hydrogen stream that includes at least 95 mol % hydrogen. The combination of a cryogenic separation system with a photocatalytic water-splitting system provides the advantage of being able to separate a highly flammable mixture of oxygen and hydrogen generated from a photocatalytic water-splitting system.

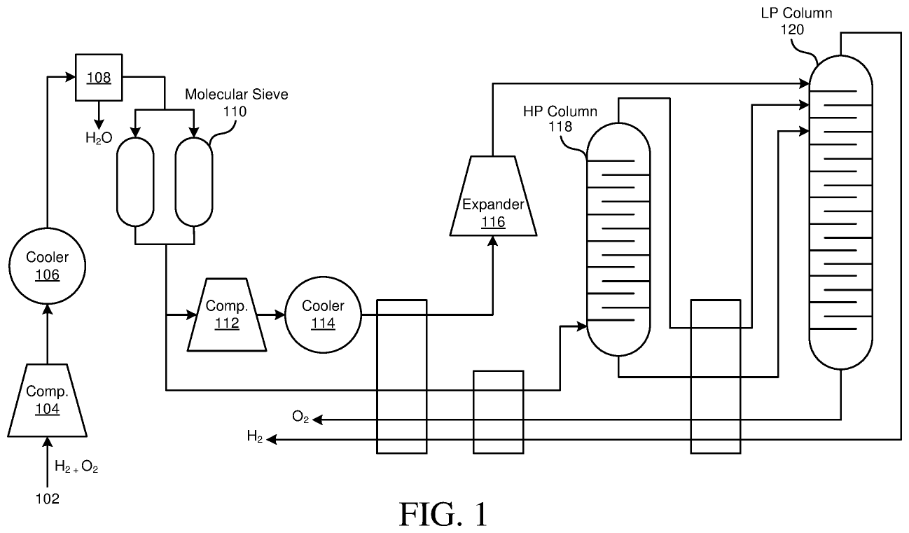

These and other non-limiting aspects of the present invention are discussed in further detail in the following sections with reference to the FIG. 1. The systems and methods of described in FIG. 1 can also include various equipment that is not shown and is known to one of skill in the art of chemical processing. For example, some controllers, piping, computers, valves, pumps, heaters, thermocouples, pressure indicators may not be shown.

### I. Cryogenic Distillation/Separation

Cryogenic distillation or separation is a technology used to separate volatile gases from a mixture by cooling the mixture until it liquefies or partially liquefies, then selectively distilling or collecting one or more gas components at their various boiling temperature under certain conditions. The process and method for cryogenic separation of a hydrogen/oxygen mixture includes one or more of the steps below.

The first process step can include filtering, compressing, and cooling the feed source. The feed source can be compressed to between 0.4 to 1.0 MPa (4 and 10 bar). The compressed feed source can be cooled such that the water vapor in the incoming feed source can be condensed and removed, as the cooled compressed feed source passes through one or more coolers. In certain aspects, the compressed feed source can be cooled in a mechanical refrigeration system. Reducing the compressed feed source temperature allows removal of additional water vapor by condensation, which can reduce the water-removal load in molecular sieve pre-purification equipment. The next step can include removal of impurities (e.g., residual water vapor and carbon dioxide (CO₂)). These components are removed prior the pre-purification treated feed source entering the distillation portion of the process because very low temperatures would cause the water and carbon dioxide to freeze and deposit on the surfaces of the process equipment.

There are two basic approaches to removing the water vapor and carbon dioxide—“molecular sieve units” and ‘reversing exchangers”. In certain embodiments, a “molecular sieve” “pre-purification unit” (PPU) is used to remove carbon dioxide and water from the incoming feed source by adsorbing these compounds onto the surface of “molecular sieve” materials. Water and CO₂ can also be removed by using “reversing” heat exchangers. In reversing heat exchangers, the cool-down of the pre-purification treated feed source is performed in brazed aluminum heat exchangers or similar apparatus. The incoming feed source stream is cooled to a low enough temperature that the water vapor and carbon dioxide freeze onto the walls of the heat exchanger, thus removing them from the feed source stream. The heat exchanger can then be switched a warming gas (e.g., a waste gas stream from the process), which heats the heat exchange such the water evaporates and carbon dioxide sublimes.

The next step can include additional heat transfer to bring the feed source to cryogenic temperature (e.g., −180° C.). This cooling can be done in brazed aluminum heat exchangers, which allow the exchange of heat between the incoming feed and cold product and waste gas streams exiting the separation process. The temperatures needed for cryogenic distillation can be created by a refrigeration process that includes expansion of one or more elevated pressure process streams.

A next step in the purification process is distillation, which separates the feed source into desired products (hydrogen and oxygen). To make the product(s), the system can use two distillation columns in series, e.g., “high” and “low” pressure columns. Hydrogen leaves the top of each distillation column and oxygen leaves from the bottom. Impure oxygen produced in the initial (higher pressure) column is further purified in the second, lower pressure column.

The cold products and waste streams that emerge from the separation columns can be routed back through the one or more end heat exchangers. As they are warmed, they can cool the incoming stream(s). The heat exchange between feed and product streams can minimize the net refrigeration load and energy consumption of the process.

A refrigeration cycle can include one or more elevated pressure streams that are reduced in pressure, which chills the stream. The pressure reduction (or expansion) takes place inside an expander (a form of turbine). Removing energy from the gas stream reduces its temperature more than would be the case with simple expansion across a valve. The energy produced by the expander is put to use to drive a process compressor, an electrical generator, or other energy-consuming device such as an oil pump or air blower.

The portions of the cryogenic separation process that operate at very low temperatures, i.e., the distillation columns, heat exchangers and cold interconnecting piping, must be well insulated. These items are typically located inside sealed “cold boxes.” Cold boxes can be “packed’ with rock wool or perlite to provide insulation and minimize convection currents.

The feed source can be produced from a photocatalytic water-splitting process and can contain about 70 mol. % H₂, 25 mol. % O₂ and 5 mol. % CO₂. In certain aspects, the source gas can be, but not necessarily, injected with hydrogen, reducing the flammability of the feed source, and compressed to increase the pressure of the source gas to the desired delivery pressure forming the feed source. Non-limiting examples of compressors include a centrifugal compressor, a piston compressor, a diaphragm compressor, a scroll compressor, or other type of compressor. In certain aspects, the gas is compressed using a centrifugal compressor. In certain aspects, the gas is compressed to approximately or at least 10, 20, 30, 40, or 50 bar (1, 2, 3, 4, or 5 MPa) and sent to an adsorption unit for gas separation. For safety, the compressor can be a spark-free or spark-suppressed compressor.

Compressed gas is used as a medium in numerous applications. Among various known techniques for compression of gas, centrifugal compressors constitute a specific example of compression devices. Centrifugal compressors achieve a pressure rise by adding kinetic energy/velocity to a continuous flow of fluid through a rotor or impeller. This kinetic energy is then converted to an increase in potential energy/static pressure by slowing the flow through a diffuser. The pressure rise in impeller is in most cases almost equal to the rise in the diffuser section. In certain aspects, the compressor has an inlet and an outlet that are controlled by valves. Various compressor types can be used, such as diaphragm type compressors, which can be obtained through PDC Machines (Warminster, Pa.) or Howden & Sundyne (Arvada, Colo.) for example; or an ionic liquid filled compressor, which can be obtained from Linde (Pittston, Pa.) for example; or a labyrinth seal piston compressor, which can be obtained from Burckhardt Compression (Houston, Tex.) for example.

After safely compressing the feed gas and producing the feed source, the feed source is sent to a cryogenic distillation unit and processed in a manner similar to that described above.

Before a fire or explosion can occur, three conditions must be met simultaneously. A fuel (e.g., hydrogen) and oxygen must exist in certain proportions, along with an ignition source, such as a spark or flame. The ratio of fuel and oxygen that is required varies with each combustible gas or vapor. Hydrogen has a wide flammability range in comparison with other fuels. For example, hydrogen has a lower explosivity limit of 4% hydrogen v/v and an upper explosivity limit of 75% hydrogen v/v in air. One aspect of the process described herein is to decrease the explosivity or flammability by increasing the amount of hydrogen above its explosivity limit or decreasing the amount of oxygen in relation to hydrogen in the feed source to an acceptable level, e.g., less than 1 mol. % O₂.

FIG. 1 illustrates a flow diagram for one embodiment of a system for performing cryogenic separation of hydrogen. FIG. 1 illustrates a scheme where a the target gas 102 that includes hydrogen is introduced to a first compressor 104 where it is compressed to increase the pressure and form a feed source. The compressed feed source can be transferred to cooler 106. The cooled feed source can then be transferred to dehydrator 108 and molecular sieve unit 110 where water and CO₂ are removed or filtered, forming a filtered feed source. The filtered feed source can be divided into a high pressure path or a low pressure path. The low pressure path can include transferring the filtered feed source stream to a second compressor 112, where it is compressed to form a compressed filtered low pressure stream. The compressed low pressure stream can then be transferred to cooler 114 where the compressed low pressure stream is further cooled. The cooled compressed low pressure stream can be passed through expander 116 and the enter low pressure column 120. In the high pressure path, the filtered feed source stream can be transferred to a high pressure column 118 for separating liquefied gas (oxygen) from non-liquefied gas (hydrogen). The separated components can then be transferred to the low pressure column 120 for final separation. The system can include various interconnecting piping, control valves and instrumentation as well as a control system for control of the system and process.

### II. Photocatalytic Water-Splitting

Photocatalytic water-splitting is the light-induced conversion reaction of water to hydrogen and oxygen. This reaction has attracted attention as one of the most promising hydrogen production processes. Photocatalytic water-splitting is an artificial process for the dissociation of water into its constituent parts, hydrogen (H₂) and oxygen (O₂), using either artificial or natural light without producing greenhouse gases or having many adverse effects on the atmosphere. When H₂O is split into O₂ and H₂, the stoichiometric ratio of its products is 2:1.

There are several requirements for a photocatalyst to be useful for water-splitting. The minimum potential difference (voltage) needed to split water is 1.23 eV at 0 pH. Since the minimum band gap for successful water-splitting at pH=0 is 1.23 eV the electrochemical requirements can theoretically reach down into infrared light, albeit with negligible catalytic activity. These values are true only for a completely reversible reaction at standard temperature and pressure (0.1 MPa (1 bar) and 25° C.). Theoretically, infrared light has enough energy to split water into hydrogen and oxygen; however, this reaction is kinetically very slow because the wavelength is greater than 380 nm. The potential must be less than 3.0 eV to make efficient use of the energy present across the full spectrum of sunlight. Water-splitting can transfer charges, but not be able to avoid corrosion for long term stability. Defects within crystalline photocatalysts can act as recombination sites, ultimately lowering efficiency.

Materials used in photocatalytic water-splitting fulfill the band requirements and typically have dopants and/or co-catalysts added to optimize their performance. A sample semiconductor with the proper band structure is titanium dioxide (TiO₂). However, due to the relatively positive conduction band of TiO₂, there is little driving force for H₂ production, so TiO₂ is typically used with a co-catalyst such as platinum (Pt) to increase the rate of H₂ production. It is routine to add co-catalysts to spur H₂ evolution in most photocatalysts due to the conduction band placement. Most semiconductors with suitable band structures to split water absorb mostly UV light; in order to absorb visible light, it is necessary to narrow the band gap.

Photocatalysts can suffer from catalyst decay and recombination under operating conditions. In certain aspects catalyst decay becomes a problem when using a sulfide-based photocatalyst such as cadmium sulfide (CdS), as the sulfide in the catalyst is oxidized to elemental sulfur at the same potentials used to split water. Thus, sulfide-based photocatalysts are not viable without sacrificial reagents such as sodium sulfide to replenish any sulfur lost, which effectively changes the main reaction to one of hydrogen evolution as opposed to water-splitting. Recombination of the electron-hole pairs needed for photocatalysis can occur with any catalyst and is dependent on the defects and surface area of the catalyst; thus, a high degree of crystallinity is required to avoid recombination at the defects.

Examples of photocatalyst include, but are not limited to NaTaO₃:La, K₃Ta₃B₂O₁₂, (Ga_{0.82}Zn_{0.18})(N_{0.82}O_{0.18}), Pt/TiO₂, and Cobalt based systems.

NaTaO₃:La—NaTaO₃:La yields a high water-splitting rate of photocatalysts without using sacrificial reagents. The nanostep structure of the material promotes water-splitting as edges functioned as H₂ production sites and the grooves functioned as O₂ production sites. Addition of NiO particles as co-catalysts assisted in H₂ production; this step can be done by using an impregnation method with an aqueous solution of Ni(NO₃).6H₂O and evaporating the solution in the presence of the photocatalyst.

K₃Ta₃B₂O₁₂—K₃Ta₃B₂O₁₂ is activated by UV light and above, does not have the performance or quantum yield of NaTaO₃:La. However, it does have the ability to split water without the assistance of co-catalysts. This ability is due to the pillared structure of the photocatalyst, which involves TaO₆ pillars connected by BO₃ triangle units.

(Ga_{0.82}Zn_{0.18})(N_{0.82}O_{0.18})—(Ga_{0.82}Zn_{0.18})(N_{0.82}O_{0.18}) has a high quantum yield in visible light for visible light-based photocatalysts that do not utilize sacrificial reagents. Tuning the catalyst is done by increasing calcination temperatures for the final step in synthesizing the catalyst. Temperatures up to 600° C. helped to reduce the number of defects, though temperatures above 700° C. can destroy the local structure around zinc atoms.

Pt/TiO₂—TiO₂ is a very efficient photocatalyst, as it yields both a high quantum number and a high rate of H₂ gas evolution, e.g., Pt/TiO₂ (anatase phase). These photocatalysts combine with a thin NaOH aqueous layer to make a solution that can split water into H₂ and O₂. TiO₂ absorbs only ultraviolet light due to its large band gap (>3.0 eV), but outperforms most visible light photocatalysts because it does not photocorrode as easily. Most ceramic materials have large band gaps and thus have stronger covalent bonds than other semiconductors with lower band gaps.

Cobalt based systems—Photocatalysts based on cobalt have been reported. Members are tris(bipyridine) cobalt(II), compounds of cobalt ligated to certain cyclic polyamines, and certain cobaloximes. Chromophores have reportedly been connected to part of a larger organic ring that surrounded a cobalt atom. The process is less efficient than using a platinum catalyst, but cobalt is less expensive, potentially reducing total costs. The process uses one of two supramolecular assemblies based on Co(II)-templated coordination as photosensitizers and electron donors to a cobaloxime macrocycle.

The examples as well as the figures are included to demonstrate preferred embodiments of the invention. It should be appreciated by those of skill in the art that the techniques disclosed in the examples or FIGURES represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

1. A process for separating hydrogen and oxygen from a gas mixture produced by photocatalytic splitting of water, the process comprising:
(a) separating hydrogen and oxygen from a photocatalytically produced feed gas by
(i) compressing a feed source gas comprising H₂, O₂, and CO₂ to about 1.0 MPa forming a compressed feed source;
(ii) filtering water and CO₂ from the compressed feed source, forming a filtered feed source;
(iii) cooling the filtered feed source to about −180° C., forming a partially liquefied feed source;
(iv) separating the partially liquefied feed source into an high pressure (HP) feed source and a low pressure (LP) feed source;
(iv) compressing the HP feed source to a pressure of at least 0.8 MPa and introducing the HP feed source into the bottom portion of a HP cryogenic separation column forming an oxygen enriched liquid at the bottom of the HP cryogenic separation column and a hydrogen enriched gas at the top of the HP cryogenic separation column;
(v) expanding the LP feed source to a temperature of less than −150° C. and a pressure of at least 0.1 MPa forming a processed LP feed source and introducing the processed LP feed source, oxygen enriched liquid from the HP column, and the hydrogen enriched gas from the HP column to a LP cryogenic distillation column; and
(vi) collecting the oxygen enriched product liquid from the bottom portion of the LP column and the hydrogen enriched product gas from the top of the LP column; and
(b) collecting, storing, and/or utilizing a hydrogen product gas and an oxygen product liquid or gas.

2. The process of claim 1, wherein the feed source is compressed to at least 1.0 MPa.

3. The process of claim 1, wherein the HP cryogenic distillation process is performed at about −120 to −150° C. and at a pressure of at least 0.8 to 2.0 MPa.

4. The process of claim 1, wherein the LP cryogenic distillation process is performed at about −180° C. and at a pressure of at least 0.2 MPa.

5. The process of claim 1, wherein the feed source comprises about 70 mol. % hydrogen.

6. The process of claim 1, wherein the enriched hydrogen product gas comprises at least 95 mol. % hydrogen.

7. A purified hydrogen product gas produced by the process of claim 1.

8. The purified hydrogen stream of claim 7, wherein the hydrogen product gas comprises at least 95 mol. % hydrogen.

9. The purified hydrogen stream of claim 7, wherein the hydrogen product gas comprises at least 99 mol. % hydrogen.

10. An oxygen enriched product gas produced by the process of claim 1.

11. The oxygen enriched product gas of claim 10, wherein the oxygen enriched product gas comprises at least 50 mol. % oxygen.

12. A gas separation system comprising:
(a) a photocatalytic reactor configured to operate at approximately atmospheric pressure and to split water into hydrogen and oxygen forming a feed gas;
(b) a high pressure cryogenic distillation column configured to receive a portion of a processed feed gas and separate the feed gas into an oxygen enriched liquid and a hydrogen enriched gas;
(c) a low pressure cryogenic distillation column configured to receive an oxygen enriched liquid and a hydrogen enriched gas from the high pressure cryogenic distillation column and produce a hydrogen product gas and an oxygen product liquid.

13. The system of claim 12, further comprising a water and CO₂ removal unit(s) configured to receive the feed gas, dry the feed gas, and remove CO₂ from the feed gas forming a processed feed gas, a portion of which is provided to a high pressure cryogenic distillation column and a portion of which is provided to a low pressure cryogenic distillation column.

14. The system of claim 12, further comprising an expander unit configured to receive at least a portion of the processed feed gas, expand the processed feed gas and provide the expanded gas/liquid to the low pressure cryogenic distillation column.

15. The system of claim 12, further comprising one or more heat exchangers through which the feed gas, processed feed gas, hydrogen feed gas, or liquid oxygen passes.

16. The system of claim 12, further comprising one or more coolers through which the feed gas, processed feed gas, hydrogen feed gas, or liquid oxygen passes.

17. The system of claim 12, further comprising one or more compressors through which the feed gas or processed feed gas passes.

18. The system of claim 12, further comprising a hydrogen storage device to collect and store at least a portion of the enriched hydrogen product gas.

19. The system of claim 12, further comprising an oxygen storage device to collect and store at least a portion of the enriched oxygen product gas.

20. The system of claim 12, further comprising one or more storage units for hydrogen product gas, oxygen product liquid, or oxygen product gas.
